(19) United States
(12) Patent Application Publication
(10) Pub. No.: US 2020/0153322 A1
(43) Pub. Date: May 14, 2020

(54) ROTOR STRUCTURE IN OUTER ROTOR TYPE ELECTRIC MOTOR

(71) Applicant: SAWAFUJI ELECTRIC CO., LTD., OTA-SHI, GUNMA (JP)

(72) Inventors: Manabu SUDA, OTA-SHI, GUNMA (JP); Tetsuro MORINAGA, OTA-SHI, GUNMA (JP); Koki KAKUAGE, OTA-SHI, GUNMA (JP); Takahiro SUGAI, OTA-SHI, GUNMA (JP)

(21) Appl. No.: 16/627,496

(22) PCT Filed: Jul. 31, 2018
(86) PCT No.: PCT/JP2018/028641

§ 371 Date: Dec. 30, 2019

(30) Foreign Application Priority Data
Aug. 4, 2017 (JP) 2017-151706

(51) Int. Cl. H02K 15/12; H02K 1/28; H02K 1/27; H02K 15/03

(52) U.S. Cl. CPC H02K 15/12; H02K 15/03; H02K 1/2786; H02K 1/28

(57) ABSTRACT

An outer rotor type electric motor is provided in which a ring-shaped yoke made of a magnetic metal is secured to an inner periphery of a plate-shaped rotor case, and includes a rotor in which a resin bonded permanent magnet is mold bonded to an inner peripheral face of the yoke, wherein an engagement portion (25a) that bites into and engages with the rotor case (23A) is formed integrally with and connected to the resin bonded permanent magnet (25). This can reliably prevent relative rotation of a resin bonded permanent magnet with respect to a rotor case when a rotor is rotating.

### TECHNICAL FIELD

The present invention relates to an outer rotor type electric motor in which a rotor that includes a rotor case formed into a plate shape having a circular end wall and a cylindrical side wall connected to an outer periphery of the end wall, a ring-shaped yoke made of a magnetic metal and secured to an inner periphery of the side wall, and a resin bonded permanent magnet mold bonded to an inner peripheral face of the yoke by means of injection molding is disposed so as to cover a stator fixed to a casing, and a rotating shaft rotatably supported on the casing is fixed to a central part of the end wall and, in particular, relates to an improvement of the rotor structure.

### BACKGROUND ART

Such an outer rotor type electric motor is already known from Patent Document 1, etc.

### RELATED ART DOCUMENTS

### Patent Documents

Patent Document 1: Japanese Patent Application Laid-open No. 2008-118789

### SUMMARY OF THE INVENTION

### Problems to be Solved by the Invention

In the outer rotor type electric motor disclosed in Patent Document 1 above, a rotor magnet formed from a resin material is mounted on a ring-shaped yoke so that part thereof is fitted into a ring-shaped fixing groove formed in the inner periphery of the yoke, and in order to a reliably prevent relative rotation of the rotor magnet with respect to a rotor case when the rotor is rotating further ingenuity is required.

The present invention has been accomplished in light of such circumstances, and it is an object thereof to provide a rotor structure in an outer rotor type electric motor that can reliably prevent relative rotation of a resin bonded permanent magnet with respect to a rotor case when a rotor is rotating.

### Means for Solving the Problems

In order to attain the above object, according to a first aspect of the present invention, there is provided a rotor structure in an outer rotor type electric motor in which a rotor comprising a rotor case formed into a plate shape having a circular end wall and a cylindrical side wall connected to an outer periphery of the end wall, a ring-shaped yoke made of a magnetic metal and secured to an inner periphery of the side wall, and a resin bonded permanent magnet mold bonded to an inner peripheral face of the yoke by means of injection molding is disposed so as to cover a stator fixed to a casing, and a rotating shaft rotatably supported on the casing is fixed to a central part of the end wall, characterized in that an engagement portion that bites into and engages with the rotor case is formed integrally with and connected to the resin bonded permanent magnet.

Further, according to a second aspect of the present invention, in addition to the first aspect, a through hole extending in an axial direction of the rotor case is provided in the rotor case, and the engagement portion is formed by a molding material filling an interior of the through hole when injection molding the resin bonded permanent magnet.

According to a third aspect of the present invention, in addition to the second aspect, the through hole is connected to a gate of an injection molding device when injection molding the resin bonded permanent magnet, and the engagement portion is formed from the molding material remaining in the through hole when injection molding is completed.

Furthermore, according to a fourth aspect of the present invention, in addition to the second or third aspect, a slit is provided at one location in a peripheral direction of the yoke, and a second engagement portion is formed by the molding material filling the slit.

### Effects of the Invention

In accordance with the first aspect of the present invention, since the engagement portion integrally connected to the resin bonded permanent magnet bites into and engages with the rotor case, it is possible to reliably fix the resin bonded permanent magnet to the rotor case so that relative rotation of the resin bonded permanent magnet with respect to the rotor case when the rotor is rotating can reliably be prevented.

Furthermore, in accordance with the second aspect of the present invention, since the engagement portion is formed by the molding material filling the interior of the through hole provided in the rotor case and extending in the axial direction of the rotor case when injection molding the resin bonded permanent magnet, it is possible to easily engage the resin bonded permanent magnet with the rotor case without complicating the structure of the rotor case side.

In accordance with the third aspect of the present invention, due to the molding material flowing through the through hole when injection molding the resin bonded permanent magnet, the structure of the injection molding device can be simplified, thereby reducing the production cost of the injection molding device.

Furthermore, in accordance with the fourth aspect of the present invention, since the second engagement portion is formed by the molding material filling the slit provided at one location in the peripheral direction of the yoke, it is possible to more reliably fix the resin bonded permanent magnet to the rotor case.

### BRIEF DESCRIPTION OF DRAWINGS

FIG. 1 is a side view of an outer rotor type electric motor of a first embodiment. (first embodiment)

FIG. 2 is a plan view from arrow 2 in FIG. 1. (first embodiment)

FIG. 3 is a sectional view along line 3-3 in FIG. 2. (first embodiment)

FIG. 4 is a perspective view when a rotor case is viewed from below. (first embodiment)

FIG. 5 is an exploded perspective view of the rotor case and a yoke from above. (first embodiment)

FIG. 6 is a vertical sectional view of an injection molding device used for injection molding a permanent magnet (first embodiment).

FIG. 7 shows a second embodiment, (a) being a vertical sectional view of a rotor case and a yoke and (b) being a perspective view of the yoke (second embodiment).

FIG. 8 shows a third embodiment, (a) being a vertical sectional view of a rotor case and a yoke and (b) being a perspective view of the yoke (third embodiment).

FIG. 9 shows a fourth embodiment, (a) being a vertical sectional view of a rotor case and a yoke and (b) being a perspective view of the yoke (fourth embodiment).

FIG. 10 shows a fifth embodiment, (a) being a vertical sectional view of a rotor case and a yoke and (b) being a perspective view of the yoke (fifth embodiment).

FIG. 11 shows a sixth embodiment and is a plan view, corresponding to FIG. 2, of an outer rotor type electric motor (sixth embodiment).

### EXPLANATION OF REFERENCE NUMERALS AND SYMBOLS

11 Casing
12 Stator
13 Rotor
14 Rotating shaft
23A, 23B Rotor case

24A, 24B, 24C, 24D, 24E Yoke
25 Resin bonded permanent magnet
25a Engagement portion (first engagement portion)
25b Second engagement portion
31A, 31B End wall
32 Side wall
50 Slit
58 Through hole
61 Gate
63 Molding material
64 Injection molding device

### MODES FOR CARRYING OUT THE INVENTION

Embodiments of the present invention are explained below by reference to the attached drawings.

### First Embodiment

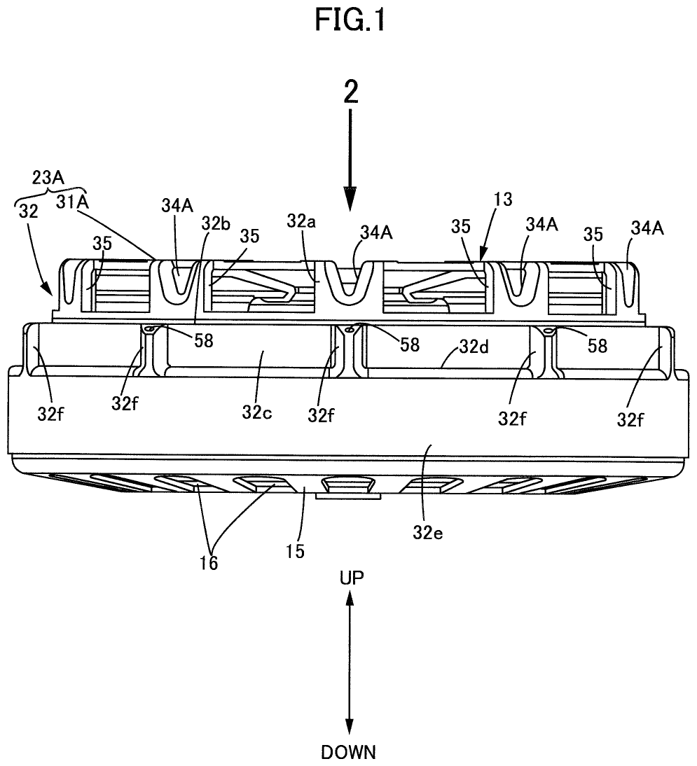

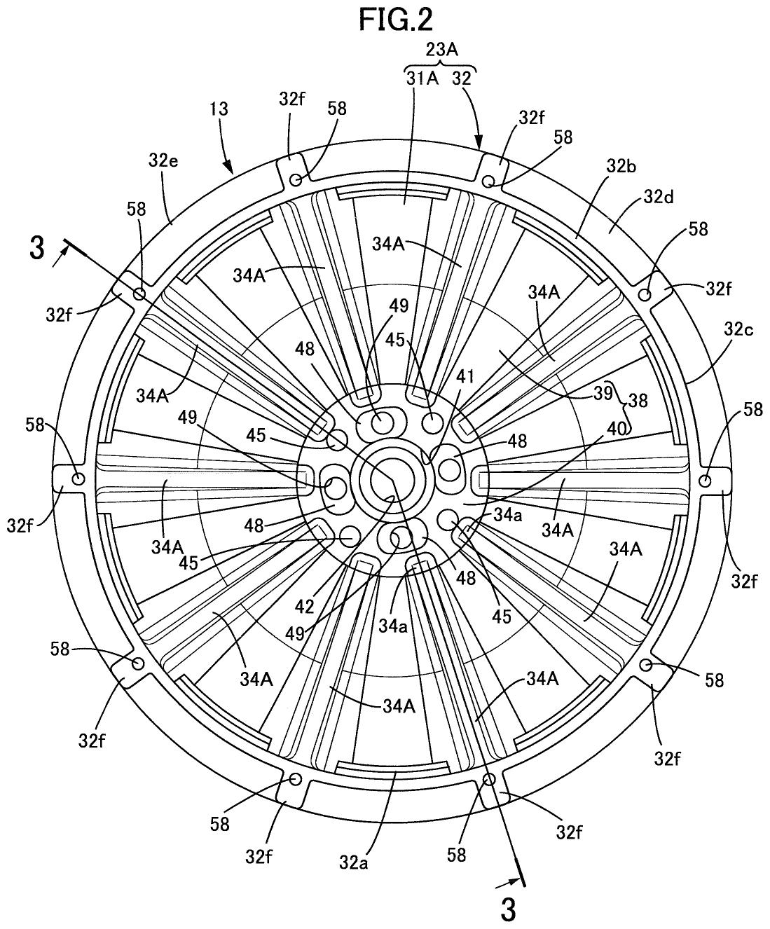

A first embodiment of the present invention is explained by reference to FIG. 1 to FIG. 6. First, in FIG. 1 to FIG. 3, this outer rotor type electric motor is used in for example a drone, and includes a stator 12 fixed to a casing 11 and a rotor 13 covering the stator 12, the rotor 13 being fixed to an upper end part of a vertically extending rotating shaft 14 disposed coaxially with the stator 12 and rotatably supported by the casing 11. A cover 15 covering the casing 11 from below is mounted on the casing 11, and a plurality of cooling air inlet holes 16 for cooling air to flow through are formed in the cover 15.

The stator 12 includes a ring-shaped stator core 17 formed by layering and joining a plurality of magnetic steel plates, a bobbin 18 made of a synthetic resin and fitted onto the stator core 17, and a coil 19 wound around the bobbin 18, and screwing a first bolt 21 inserted through a through hole 20 provided at a plurality of locations spaced in the peripheral direction of the stator core 17 into the casing 11 and tightening fixes the stator 12 to the casing 11.

The rotor 13 is formed from a rotor case 23A made of a light metal or a synthetic resin and fastened to the rotating shaft 14, a ring-shaped yoke 24A made of a magnetic metal and fixed by for example press fitting into an inner peripheral face of the rotor case 23A, and a resin bonded permanent magnet 25 provided on an inner peripheral face of the yoke 24A, the light metal being for example aluminum, magnesium or titanium, etc.

A support hole 26 having a vertically extending axis is provided in a central part of the casing 11, and a lower end part of the rotating shaft 14 inserted through the support hole 26 is rotatably supported on the casing 11 via a first ball bearing 27. That is, an inner race 27b of the first ball bearing 27 is press fitted onto the lower end part of the rotating shaft 14, an upper face of an outer race 27a of the first ball bearing 27 is abutted against a first annular step portion 26a formed on a lower part of the support hole 26 so as to face downward, and an outer peripheral part of a disk-shaped plate 30 fastened to the lower end part of the rotating shaft 14 by means of a plurality of second bolts 29 is abutted against a lower face of the inner race 27b of the first ball bearing 27.

An intermediate part of the rotating shaft 14 is rotatably supported on the casing 11 via a second ball bearing 28. That is, an inner race 28b of the second ball bearing 28 is press fitted onto the rotating shaft 14 so that the upper end of the inner race 28b abuts against a third annular step portion 14a formed on the intermediate part of the rotating shaft 14 and facing downward, and a lower face of an outer race 28a of the second ball bearing 28 is disposed so as to closely oppose or abut against a second annular step portion 26b formed on an upper part of the support hole 26 so as to face upward.

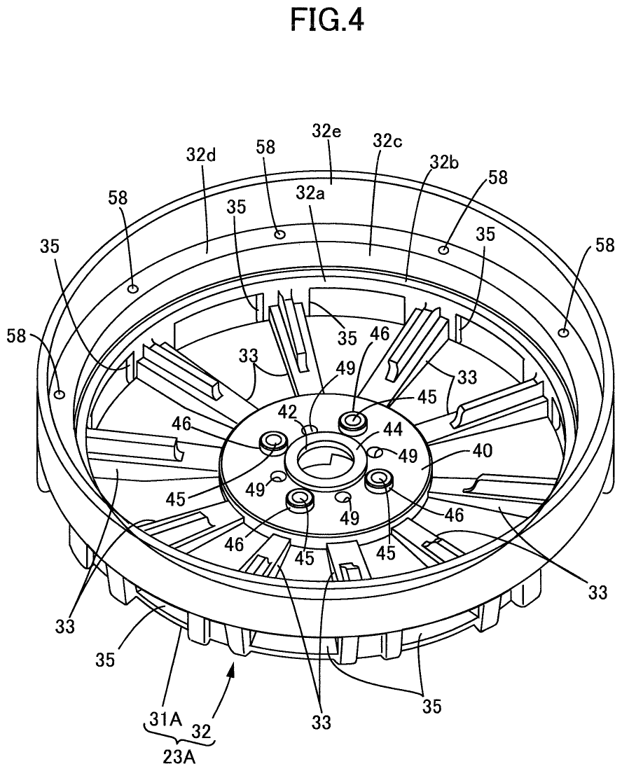

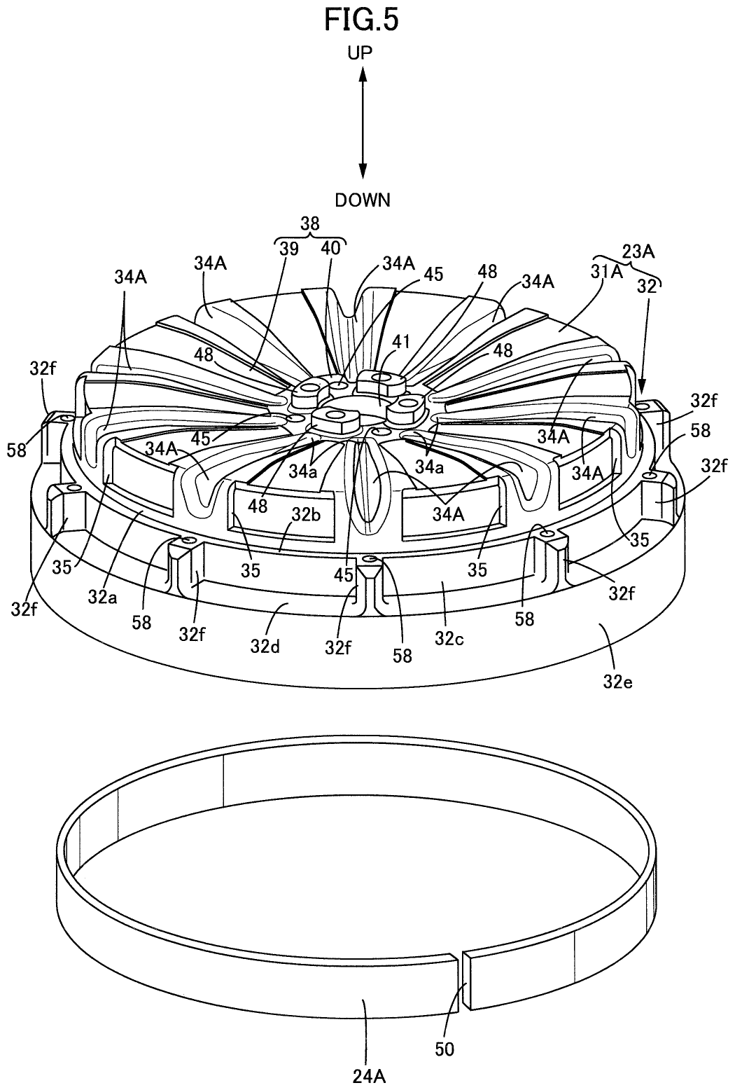

Referring in addition to FIG. 4 and FIG. 5, the rotor case 23A is formed into a plate shape opening downward while integrally having a circular end wall 31A covering the stator 12 from above and a cylindrical side wall 32 connected to the outer periphery of the end wall 31A so as to cover the stator 12 from the outside.

The side wall 32 is formed into a stepped cylindrical shape by coaxially connecting a first cylindrical portion 32a that has a cylindrical shape and is connected to the outer periphery of the end wall 31A, a second cylindrical portion 32c formed so as to have a larger diameter than that of the first cylindrical portion 32a so as to form a fourth annular step portion 32b facing upward between itself and the lower end of the first cylindrical portion 32a, and a third cylindrical portion 32e formed so as to have a larger diameter than that of the second cylindrical portion 32c so as to form a fifth annular step portion 32d facing upward between itself and the lower end of the second cylindrical portion 32c . A vertically extending reinforcing rib 32f is integrally formed at a plurality of locations (ten locations in the first embodiment) equally spaced in the peripheral direction of the second cylindrical portion 32c and the fifth annular step portion 32d.

A plurality of (ten in the first embodiment) cooling blades 33 sucking in cooling air for cooling the stator 12 from beneath the stator 12, that is, from the cooling air inlet hole 16 formed in the cover 15, are provided integrally with the end wall 31A so as to extend radially while protruding downward from a lower face of the end wall 31A and have an outer end part connected to the first cylindrical portion 32a of the side wall 32 in a portion corresponding to the reinforcing rib 32f . A plurality of (ten in the first embodiment) cooling air discharge holes 35 discharging air from the cooling blade 33 to the exterior are formed in the first cylindrical portion 32a of the side wall 32 so as to be disposed between the reinforcing ribs 32f.

A recess part 38 is formed in a central part of an upper face of the end wall 31A. The recess part 38 is formed into, for example, a bowl shape in this embodiment from a tapered inclined wall 39 having a decreasing diameter in going toward the central part of the end wall 31A and a bottom wall 40 connected to the lower end of the inclined wall 39, but may be formed so as to generate a stair-like step. Formed in a central part of the bottom wall 40 are a cutout hole 41 and a fitting hole 42 coaxially connected to the lower end of the cutout hole 41 and having a smaller diameter than that of the cutout hole 41.

Formed in the upper face of the end wall 31A so as to individually correspond to the cooling blades 33 are grooves 34A extending radially from the recess part 38 to the outer periphery of the end wall 31A in order to discharge water from the central part of the upper face of the end wall 31A.

With regard to the groove 34A, its bottom part is formed in an inclined manner so as to be positioned further downward in going outward in the radial direction of the end wall 31A, and an inner end portion 34a of the groove 34A along the radial direction of the end wall 31A is formed so as to be deeper than the recess part 38. That is, the bottom of the inner end portion 34a of the groove 34A is positioned further downward than an upper face of the bottom wall 40 of the recess part 38, and the bottom of the groove 34A is inclined so as to go away from a virtual horizontal plane VH passing through the bottom of the inner end portion 34a in going outward in the radial direction of the end wall 31A.

The upper end part of the rotating shaft 14 is fastened to a lower face of the bottom wall 40 of the recess part 38 in the central part of the upper face of the end wall 31A, a flange 43 is formed integrally with the upper end part of the rotating shaft 14, and a portion, projecting from the flange 43, of the upper end part of the rotating shaft 14 is fitted into the fitting hole 42 of the end wall 31A. A bottomed cutout hole 51 having its upper end opening in the cutout hole 41 is formed in the rotating shaft 14 so as to be coaxial therewith.

A ring-shaped support abutment projecting part 44 forming part of the fitting hole 42 is projectingly provided on the lower face of the bottom wall 40, and a first mounting boss 46 is integrally and projectingly provided on the lower face of the bottom wall 40 at a plurality of locations (for example four locations) equally spaced in the peripheral direction of the cutout hole 41, the first mounting boss 46 forming part of a first mounting hole 45 disposed in an area around the cutout hole 41 and projecting downward.

On the other hand, the flange 43 is formed so as to integrally have a ring-shaped flange base portion 43a abutting against the support abutment projecting part 44 from below, and a plurality of (for example four) mounting arm portions 43b protruding outward from the flange base portion 43a so as to abut against the first mounting boss 46 from below. Inserting a third bolt 47, having an enlarged diameter head portion 47a abutting against and engaging with the mounting arm portion 43b from below, through the mounting arm portion 43b and screwing it into the first mounting hole 45 fastens the upper end part of the rotating shaft 14 to the lower face of the bottom wall 40 of the end wall 31A. Moreover, the upper end of the first mounting hole 45 opens on the upper face of the bottom wall 40, and part of the third bolt 47 (an upper end part in the embodiment) is exposed to the exterior from the end wall 31A.

A second mounting boss 48 disposed between the first mounting holes 45 around the cutout hole 41 is projectingly provided integrally with the upper face of the bottom wall 40 so as to project upward while having a second mounting hole 49, and a propeller (not illustrated) of the drone is fastened to the second mounting bosses 48.

Referring to FIG. 5, the yoke 24A is formed into a ring shape having a slit 50 at one location in the peripheral direction and is fixed by for example press fitting into the inner periphery of the third cylindrical portion 32e of the rotor case 23A.

The resin bonded permanent magnets 25 are mold bonded to the inner peripheral face of the yoke 24A by injection molding so that they have a ring shape overall, and polarized so that there are a plurality of north poles and a plurality of south poles on each of the outer peripheral side and the inner peripheral side of the resin bonded permanent magnet 25 and so that poles adjacent to each other in the peripheral direction of the yoke 24A have different polarities on the outer peripheral side and the inner peripheral side. It is also desirable in order to prevent degradation of the performance that the north pole and the south pole of the resin bonded permanent magnets 25 are magnetized so that the slit 50 of the yoke 24A is positioned in the central part in the peripheral direction of a north pole or a south pole.

Formed integrally with and connected to the resin bonded permanent magnet 25 is a first engagement portion 25a that bites into and engages with the rotor case 23A. In this embodiment the first engagement portion 25a is formed at ten locations equally spaced in the peripheral direction of the resin bonded permanent magnet 25.

Each of the plurality of (ten in this embodiment) reinforcing ribs 32f of the rotor case 23A is provided in advance with a through hole 58 extending in the axial direction of the rotor case 23A and having upper and lower ends open. The first engagement portion 25a is formed by a molding material 63 filling the interior of the through hole 58 when injection molding the resin bonded permanent magnet 25.

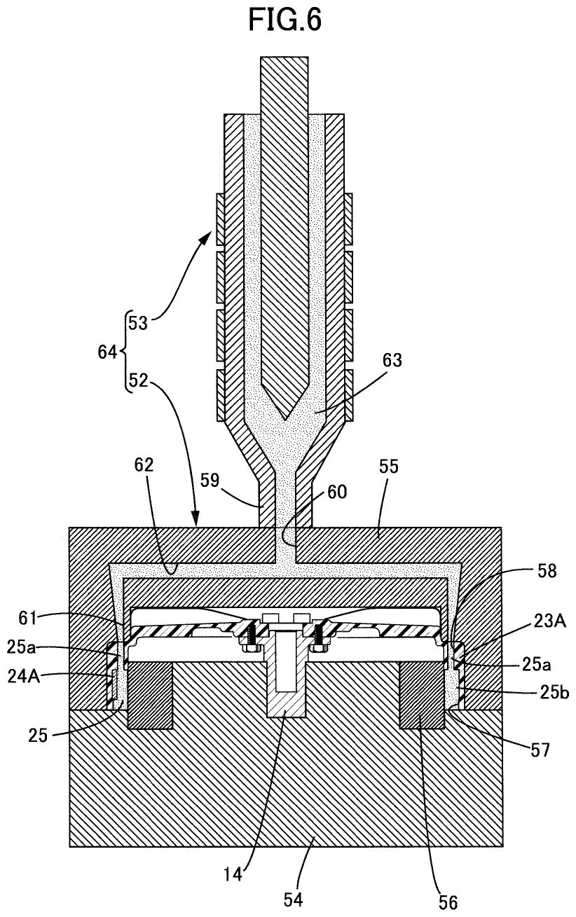

When injection molding the resin bonded permanent magnets 25, an injection molding device 64 shown in FIG. 6 is used, and this injection molding device 64 is formed from a molding device 52 and an injection device 53.

The molding device 52 includes a first mold 54, a second mold 55 disposed above the first mold 54 so as to hold between itself and the first mold 54 the rotor case 23A having the rotating shaft 14 fastened thereto and the yoke 24A press fitted thereinto, and a ring-shaped magnetizing magnet 56 mounted on the first mold 54. A cavity 57 is formed by cooperation of the first mold 54, the second mold 55, the magnetizing magnet 56, the rotor case 23A and the yoke 24A. That is, when injection molding the resin bonded permanent magnet 25, the rotor case 23A having the rotating shaft 14 fastened thereto and the yoke 24A press fitted thereinto is set in the molding device 52.

Formed in the second mold 55 are a sprue 60 connected to a nozzle 59 at the extremity of the injection device 53, a plurality of gates 61 connected to the through holes 58, and a runner 62 joining the gate 61 and the sprue 60. The powder molding material 63, which is formed by covering a magnetic powder with a coating resin, is heated, melted, and then injected from the nozzle 59 of the injection device 53, it being injected into the cavity 57 from the nozzle 59 via the sprue 60, the runner 62, the gate 61 and the through hole 58. The hot molten molding material 63 is magnetized by means of the magnetizing magnet 56 at the same time as molding in the cavity 57, and the resin bonded permanent magnets 25 integrated into a ring shape are mold bonded to the inner peripheral face of the yoke 24A (by resin fixing due to molding and the magnetic attractive force between the resin bonded permanent magnet 25 and the yoke 24A).

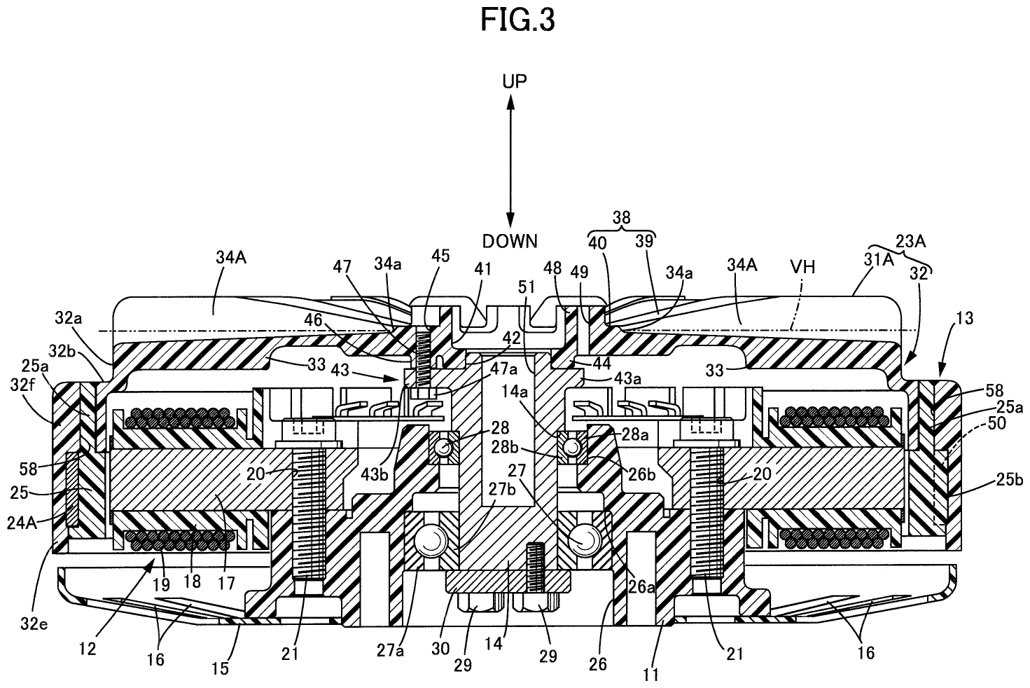

The first engagement portion 25a is formed with the molding material 63 remaining in the through hole 58 when the injection molding is completed, and a second engagement portion 25b (see FIG. 3 and FIG. 6) biting into and engaging with the yoke 24A is formed integrally with and connected to the resin bonded permanent magnet 25 by the molding material 63 filling the slit 50 of the yoke 24A.

The operation of the first embodiment is now explained. The rotor 13 of the outer rotor type electric motor includes the rotor case 23A, which is formed into a plate shape having the circular end wall 31A and the cylindrical side wall 32 connected to the outer periphery of the end wall 31A, and the plurality of resin bonded permanent magnets 25, which are fixed to the inner periphery of the side wall 32, and the upper end part of the rotating shaft 14 having a vertically extending axis is fastened to the central part of the end wall 31A by means of the third bolt 47 having part thereof exposed to the exterior from the upper face of the end wall 31A. Since the plurality of cooling blades 33, which suck in cooling air for cooling the stator 12 from beneath the stator 12, are provided integrally with the end wall 31A so as to extend radially while projecting downward from the lower face of the end wall 31A, the radially extending grooves 34A for discharging water from the central part of the upper face of the end wall 31A are formed in the upper face of the end wall 31A so as to individually correspond to the cooling blades 33, and the plurality of cooling air discharge holes 35, which discharge air from the cooling blade 33 to the exterior, are formed in the side wall 32, it is possible for air sucked in from beneath the stator 12 by means of the cooling blades 33 due to rotation of the rotor case 23A to pass through the stator 12 and cool the stator 12. Moreover, since the radially extending grooves 34A for discharging water that has built up on the upper face of the end wall 31A are formed in the upper face of the end wall 31A so as to individually correspond to the cooling blades 33, it is possible to simultaneously form the cooling blade 33 and the groove 34A while suppressing any increase in the number of components and any increase in the weight of the rotor case 23A, and despite the cooling blade 33 being provided on the end wall 31A of the rotor case 23A it is possible to prevent a bolt from becoming rusty by preventing rain water, etc. from building up on the upper face of the end wall 31A while simplifying the production process and reducing the cost.

Furthermore, since the recess part 38 is formed in the central part of the upper face of the end wall 31A, and the upper end part of the rotating shaft 14 is fastened to the lower face of the bottom wall 40 of the recess part 38, it is possible to shorten the rotating shaft 14 as much as possible and lighten the weight, and it is also possible to ensure that there is a space for disposing the cooling blade 33 while suppressing the axial length of the rotor case 23A.

Furthermore, since the inner end portion 34a of the groove 34A along the radial direction of the end wall 31A is formed so as to be deeper than the recess part 38, it is possible to discharge water from the central part of the end wall 31A even in a state in which the rotor 13 is not rotating. Moreover, since the bottom part of the groove 34A is formed in an inclined manner so that it is positioned further downward in going in the radially outward direction of the end wall 31A, it is possible to discharge water from the central part of the end wall 31A more effectively.

Since the first engagement portion 25a biting into and engaging with the rotor case 23A is formed so as to be connected integrally with the resin bonded permanent magnet 25, it is possible to reliably fix the resin bonded permanent magnet 25 to the rotor case 23A so as to reliably prevent relative rotation of the resin bonded permanent magnet 25 with respect to the rotor case 23A when the rotor 13 is rotating.

Furthermore, since the through hole 58 extending in the axial direction of the rotor case 23A is provided in the rotor case 23A, and the first engagement portion 25a is formed by the molding material 63 filling the interior of the through hole 58 when injection molding the resin bonded permanent magnet 25, it is possible to easily engage the resin bonded permanent magnet 25 with the rotor case 23A without complicating the structure of the rotor case 23A side.

Moreover, since the through hole 58 is connected to the gate 61 of the injection molding device 64 when injection molding the resin bonded permanent magnet 25, and the first engagement portion 25a is formed from the molding material 63 remaining in the through hole 58 when injection molding is completed, it is possible, by making the molding material 63 flow through the through hole 58 when injection molding the resin bonded permanent magnet 25, to simplify the structure of the injection molding device 64, thereby reducing the production cost of the injection molding device 64.

Furthermore, since the slit 50 is provided at one location in the peripheral direction of the yoke 24A, it becomes easy to adjust the dimensions when press fitting the yoke 24A into the rotor case 23A, and since the second engagement portion 25b is formed by the molding material 63 filling the slit 50, it is possible to more reliably fix the resin bonded permanent magnet 25 to the rotor case 23A.

Moreover, since the rotor case 23A having the rotating shaft 14 fastened thereto and the yoke 24A press fitted thereinto is set in the molding device 52 when injection molding the resin bonded permanent magnet 25, it is possible, in a single operation, to mold the resin bonded permanent magnet 25 and mount the resin bonded permanent magnet 25 on the rotor case 23A, thereby cutting the number of steps and reducing the cost. Furthermore, it becomes easy to make the central axis of the rotor case 23A, the central axis of the rotating shaft 14, and the central axis of the inner peripheral face of the resin bonded permanent magnet 25 coincide with each other, and it is possible, by ensuring the dimensional precision of the internal diameter of the resin bonded permanent magnet 25 by reference to the central axis of the rotating shaft 14, to reduce an air gap between the resin bonded permanent magnet 25 and the stator 12, thus improving the output performance and contributing to a reduction in the dimensions and weight of the outer rotor type electric motor.

### Second Embodiment

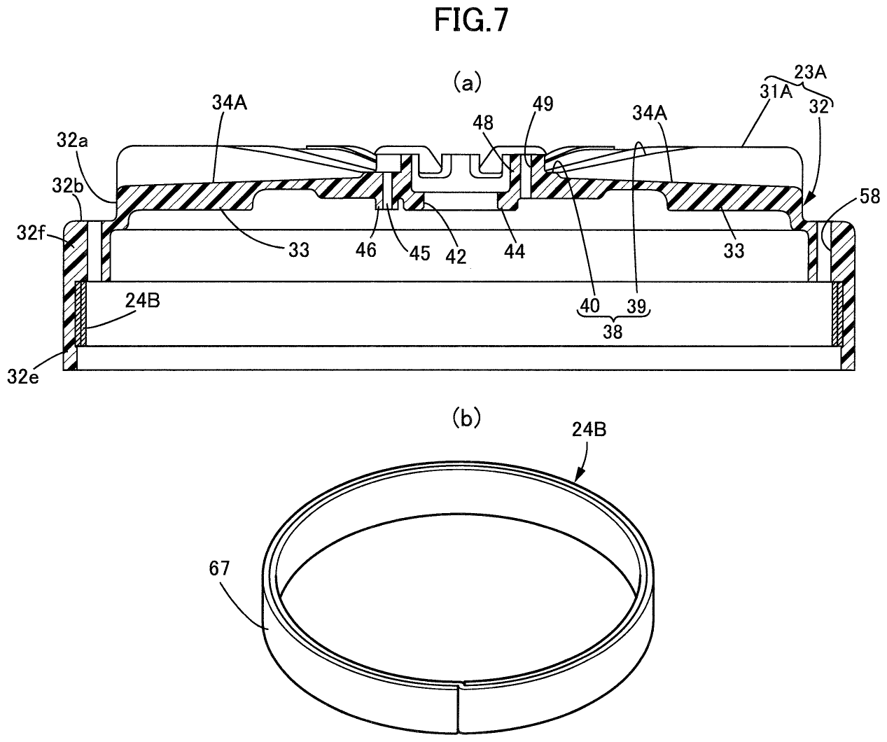

As a second embodiment of the present invention, as shown in FIG. 7, a yoke 24B may be formed by winding a magnetic metal band plate 67 around a plurality of times or only once (twice in this embodiment).

### Third Embodiment

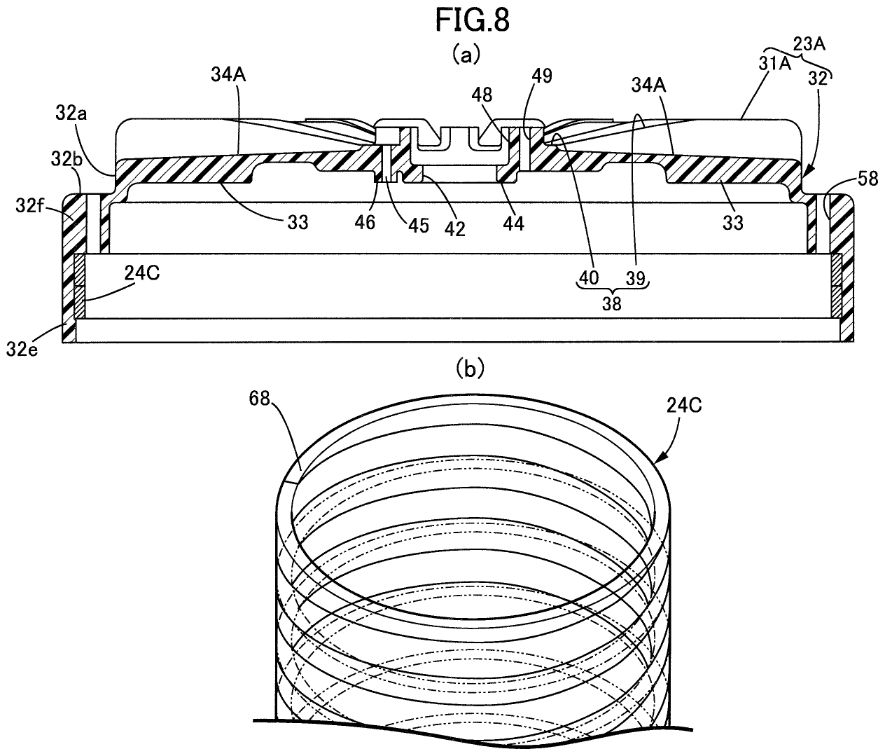

As a third embodiment of the present invention, as shown in FIG. 8, a yoke 24C may be formed by winding a magnetic metal band plate 68 into a helical shape, and in this case the yoke 24C may be formed by cutting out a required length as shown by a chain line in FIG. 8 (b) from a lengthwise-extending cylindrical part that is formed by winding the band plate 68 into a helical shape.

### Fourth Embodiment

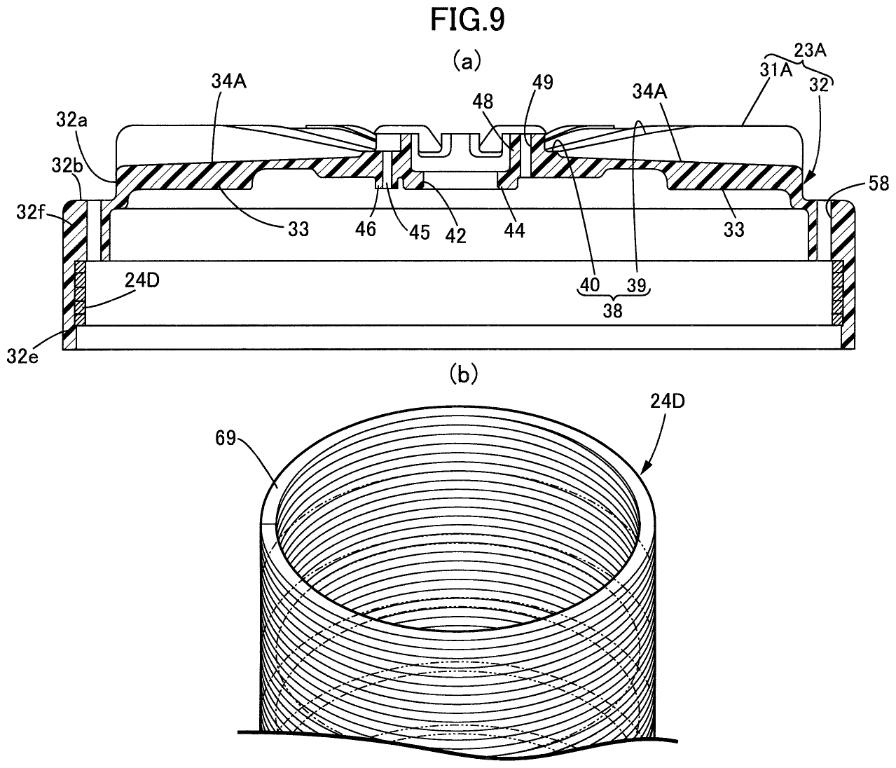

As a fourth embodiment of the present invention, as shown in FIG. 9, a yoke 24D may be formed by winding into a helical shape a wire rod 69 made of a magnetic metal and having a rectangular cross-sectional shape, and in this case the yoke 24D may be formed by cutting out a required length as shown by a chain line in FIG. 9 (b) from a lengthwise-extending cylindrical part that is formed by winding the wire rod 69 into a helical shape.

### Fifth Embodiment

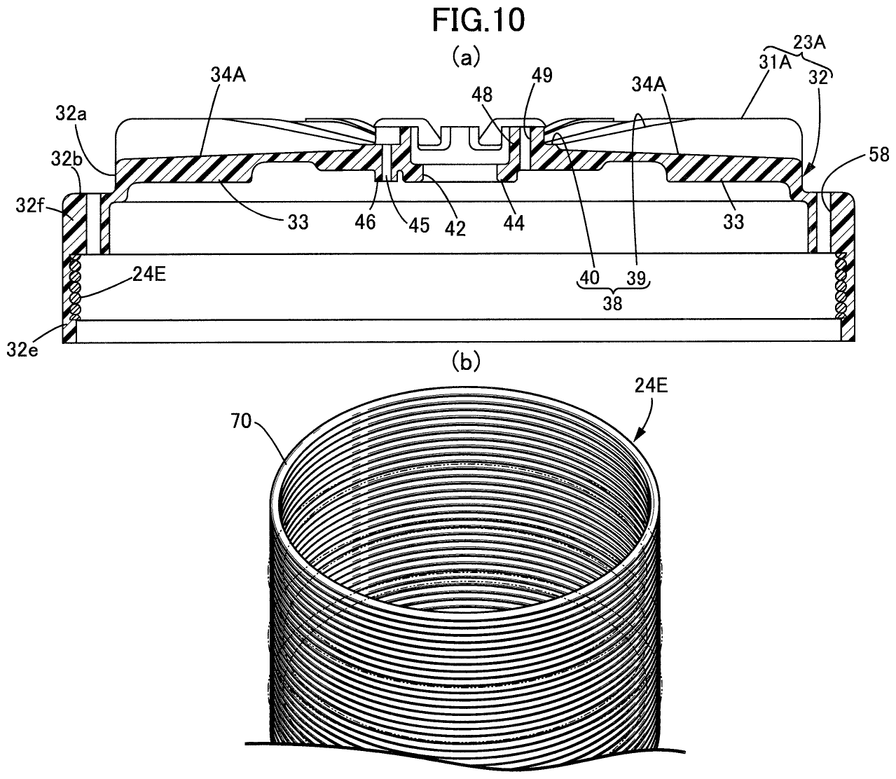

As a fifth embodiment of the present invention, as shown in FIG. 10, a yoke 24E may be formed by winding into a helical shape a wire rod 70 made of a magnetic metal and having a circular cross-sectional shape, and in this case the yoke 24E may be formed by cutting out a required length as shown by a chain line in FIG. 10 (b) from a lengthwise-extending cylindrical part that is formed by winding the wire rod 70 into a helical shape. Moreover, the yoke 24E is fixed to the inner peripheral face of the third cylindrical portion 32e of the rotor case 23A by being screwed into the third cylindrical portion 32e; when carrying out this screwing, a female thread may be formed in advance in the inner peripheral face of the third cylindrical portion 32e, and by so doing it is possible to make the central axis of the yoke 24E coincide with the central axis of the rotor case 23A with good precision by enhancing the precision of the female thread. Furthermore, it is desirable that the direction in which the yoke 24E is screwed into the third cylindrical portion 32e is opposite to the rotational direction of the rotor case 23A, that is, the rotational direction of the rotating shaft 14 (see the first embodiment); by so doing an effect of further screwing the yoke 24E into the third cylindrical portion 32e is obtained in response to rotation of the rotating shaft 14, and the yoke 24E is more reliably fixed to the inner peripheral face of the third cylindrical portion 32e. Sixth Embodiment

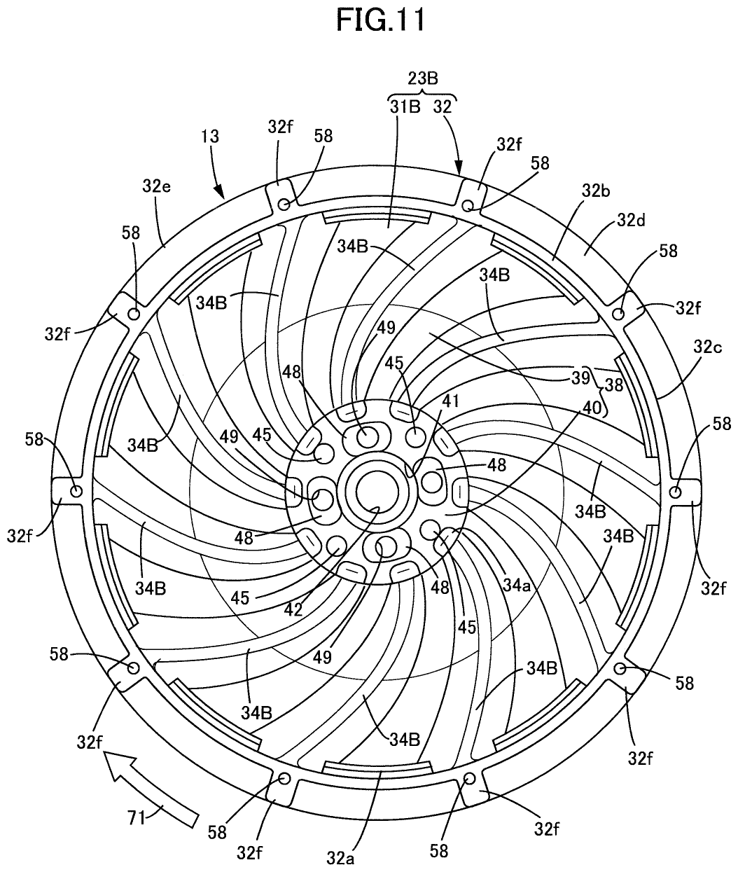

A sixth embodiment of the present invention is explained by reference to FIG. 11. A rotor case 23B is formed into a plate shape opening downward while integrally having a circular end wall 31B and a cylindrical side wall 32 connected to the outer periphery of the end wall 31B. A recess part 38 is formed in a central part of an upper face of the end wall 31B.

In order to discharge water from the central part of the upper face of the end wall 31B, a plurality of grooves 34B are formed in the upper face of the end wall 31B so as to extend from the recess part 38 up to the outer periphery of the end wall 31B, while having a spiral shape that is curved so as to be positioned further on the outer side in the radial direction of the end wall 31B in going forward in a rotational direction 71 of the rotor case 23B. Spiral cooling blades (not illustrated) are formed on a lower face of the end wall 31B so as to individually correspond to the grooves 34B.

In accordance with the sixth embodiment, since the cooling blade and the groove 34B are spiral, the flow of air of the rotor interior is accelerated, and the stator 12 (see first embodiment) can be cooled more effectively.

Embodiments of the present invention are explained above, but the present invention is not limited to the above embodiments and may be modified in a variety of ways as long as the modifications do not depart from the subject matter thereof.

1. A rotor structure in an outer rotor type electric motor in which a rotor comprising a rotor case formed into a plate shape having a circular end wall and a cylindrical side wall connected to an outer periphery of the end wall, a ring-shaped yoke made of a magnetic metal and secured to an inner periphery of the side wall, and a resin bonded permanent magnet mold bonded to an inner peripheral face of the yoke by means of injection molding is disposed so as to cover a stator fixed to a casing, and a rotating shaft rotatably supported on the casing is fixed to a central part of the end wall, characterized in that wherein an engagement portion that bites into and engages with the rotor case is formed integrally with and connected to the resin bonded permanent magnet.

2. The rotor structure in an outer rotor type electric motor according to claim 1, wherein a through hole extending in an axial direction of the rotor case is provided in the rotor case, and the engagement portion is formed by a molding material filling an interior of the through hole when injection molding the resin bonded permanent magnet.

3. The rotor structure in an outer rotor type electric motor according to claim 2, wherein the through hole is connected to a gate of an injection molding device when injection molding the resin bonded permanent magnet, and the engagement portion is formed from the molding material remaining in the through hole when injection molding is completed.

4. The rotor structure in an outer rotor type electric motor according to claim 2, wherein a slit is provided at one location in a peripheral direction of the yoke, and a second engagement portion is formed by the molding material filling the slit.

5. The rotor structure in an outer rotor type electric motor according to claim 3, wherein a slit is provided at one location in a peripheral direction of the yoke, and a second engagement portion is formed by the molding material filling the slit.
